(19) United States
(12) Patent Application Publication
(10) Pub. No.: US 2022/0002967 A1
(43) Pub. Date: Jan. 6, 2022

(54) Dirt Screening Bucket Attachment Device

(71) Applicant: Thomas Sampson, Plaistow, NH (US)

(72) Inventor: Thomas Sampson, Plaistow, NH (US)

(21) Appl. No.: 17/366,152

(22) Filed: Jul. 2, 2021

Related U.S. Application Data
(60) Provisional application No. 63/048,419, filed on Jul. 6, 2020.

(51) Int. Cl. E02F 7/00; E02F 3/14; B07B 1/46

(52) U.S. Cl. CPC E02F 7/00; B07B 1/4681; E02F 3/141

(57) ABSTRACT

The present invention relates generally to a dirt screening bucket attachment device for use with an existing bucket of a skid steer, or other similar type of earth-moving machinery. More specifically, the device can be readily attached/detached to the existing bucket of the skid steer to allow a user to quickly and efficiently screen dirt, topsoil and other materials for rocks, roots and other unwanted debris by moving and articulating the bucket of the skid steer with the attachment attached thereto and in an engaged position. In addition, the attachment device may be easily articulated from a position that covers said bucket to a position above said bucket (i.e., thereby leaving the bucket opening exposed) via a hydraulic system that allows a user to utilize the full functionality of the bucket without interference from the bucket attachment device.

### CROSS-REFERENCE TO RELATED APPLICATION

The present application claims priority to, and the benefit of, U.S. Provisional Application No. 63/048,419, which was filed on Jul. 6, 2020 and is incorporated herein by reference in its entirety.

### FIELD OF THE INVENTION

The present invention relates generally to a dirt screening bucket attachment device for use with an existing bucket of a skid steer or other similar type of earth-moving machinery. More specifically, the invention relates to a dirt screening bucket attachment device for use with a skid steer. The device can be readily attached/detached to the existing bucket of the skid steer to allow a user to quickly and efficiently screen dirt, topsoil and other materials for rocks, roots and other unwanted debris by moving and articulating the bucket of the skid steer with the attachment attached thereto and in an engaged position. In addition, the attachment device may be easily articulated from a position that covers said bucket to a position above said bucket (i.e., leaving the bucket opening exposed) via a hydraulic system that allows a user to utilize the full functionality of the bucket without interference from the bucket attachment device. Accordingly, the present specification makes specific reference thereto. However, it is to be appreciated that aspects of the present invention are also equally amenable to other like applications, devices and methods of manufacture.

### BACKGROUND OF THE INVENTION

In the construction and building industry, there is a need for machinery that is capable of both moving and screening significant amounts of dirt, topsoil and other substances for rocks, roots and other debris at a rate which could not otherwise be accomplished by hand. Currently, several devices and methods exist in the art which attempt to satisfy this need. One such method for screening dirt, topsoil and the like involves using a skid steer loader or other earth-moving equipment that utilizes a designated attachment in lieu of the existing bucket of the machine, wherein said attachment is specifically designed to allow a user to screen dirt, topsoil, and the like to remove unwanted debris such as rocks, roots, garbage or other debris. However, existing methods and devices for screening dirt/topsoil contain a plurality of inherent limitations and drawbacks, such as those described below.

Existing attachment devices for skid steers or other pieces of earth-moving equipment primarily suffer from two inherent drawbacks. More specifically, a traditional skid steer dirt screening bucket attachment cannot be readily attached (without significant modification) to an existing, stand-alone skid steer bucket. As such, many dirt-screening skid steer attachments are comprised of a means to screen topsoil while also being comprised of a bucket that is fixedly and inseparably attached to said means. This severely limits existing attachments in several ways, with the two most apparent being practicality and price.

For example, from a practical standpoint, existing attachments for skid steers are normally solely optimized for the screening of dirt, thereby prohibiting a user from using the attachment for simply moving/spreading dirt in an optimized and effective manner, which could otherwise be done via the machine's existing bucket. As such, if a user wishes to use a dirt-screening bucket attachment and then move said dirt after it has been screened, the user must first remove the combination bucket/screen attachment and then reattach the traditional bucket of the machine to do so. In a practical sense, this process amounts to a fundamental inefficiency that requires both additional time and effort on the part of the user. Therefore, a dirt-screening attachment that can readily be attached/detached from an existing skid steer or other earth-moving equipment buckets to allow for the user to fully utilize the existing bucket without having to subsequently remove the dirt screening attachment is desired.

In addition, existing dirt-screening attachment devices can be extremely expensive, costing upwards of several thousands of dollars. This is largely because existing dirt-screening attachment devices are comprised of both a bucket and a screening device, thereby forcing a buyer to pay for both devices even if only one is needed, and thus increasing the price of the same. Further, a buyer may be required to purchase the entire device even if he or she has an existing bucket that could otherwise be used for non-screening purposes, which also results in the buyer having to store, move and maintain two separate devices.

Therefore, there exists a long felt need in the art for a dirt-screening bucket attachment device that can be easily and removably attached to the existing bucket of a skid steer or other piece of earth-moving machinery. There also exists a long felt need in the art for a dirt screening bucket attachment that may remain attached to the bucket of the skid steer or other earth moving machinery such that it does not unduly interfere with the operation of bucket when the dirt screening attachment is not needed. Finally, there is a long felt need in the art for a dirt-screening bucket attachment for skid steers and other machinery of the like that provides a lower cost alternative to existing dirt-screening attachments that are comprised of both a bucket portion and a dirt-screening portion.

The present invention, in one exemplary embodiment, discloses a dirt-screening bucket attachment device for use with an existing bucket of a skid steer or other similar type of earth-moving machinery. More specifically, the bucket attachment device is comprised of a frame, a top screen portion, a front screen portion, opposing side members that mount to an existing skid steer bucket via a mounting assembly and a hydraulic assembly for articulating the device. In operation, the dirt-screening bucket attachment device may be articulated between an engaged position, wherein the attachment is placed directly over and covers the opening of the bucket (e.g., to be used to screen the dirt or topsoil within the bucket) and a disengaged or stowed position, wherein the attachment is raised above or away from the bucket opening by the hydraulic arm assembly, such that it does not otherwise interfere with the traditional operation of the bucket. The hydraulic assembly of the device is preferably comprised of a plurality of hinges, pistons and hoses that may be in power communication with the existing hydraulic system of the skid steer device or other earth-moving machinery. Further, the dirt-screening bucket attachment device can be relatively easily and removably attached to an existing skid steer bucket, or other earth-moving machinery of the like.

In this manner, the dirt-screening bucket attachment device of the present invention may be used with a bucket of a skid steer and/or other earth-moving machinery and thus accomplishes all of the forgoing objectives by providing the user with an economical alternative to existing dirt-screening devices that are normally comprised of both a bucket and a dirt-screening mechanism. Further, the dirt-screening bucket attachment device of the present invention also provides a user with the means to screen dirt, topsoil and other materials when desired, while also retaining the functionality of the existing bucket (i.e., without having to physically remove the screening apparatus from the bucket or change the bucket).

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one embodiment thereof, comprises a dirt-screening bucket attachment device for use with the existing bucket of a skid steer or other piece of earth-moving machinery. In one embodiment of the present invention, the dirt-screening bucket attachment device is comprised of a frame, a top screen portion, a front screen portion, opposing side members that mount to an existing skid steer bucket via a mounting assembly and a hydraulic assembly. The frame is preferably comprised of a structural steel or other suitable and durable material and is also comprised of at least one mounting shaft that engages a mounting receiver which mounts to an existing bucket via the mounting assembly of the present invention. Further, the top and front screens of the device allow the user to screen dirt, topsoil, and other substances via shaking the device while raising and lowering the bucket of the skid steer via the hydraulic assembly with the screening device attached to the bucket and in the engaged position.

More specifically, as the bucket is being shaken and raised/lowered, finer particles such as dirt and topsoil are permitted to pass through the top and front screens with the assistance of gravity, while larger particles such as rocks, roots, and other debris are prevented from passing through the screens and may be appropriately disposed of later. In addition, once the dirt, topsoil and other materials of the like have been properly screened and the rocks and other debris have been properly disposed of, the hydraulic assembly may be used to reposition the device from the engaged position to a disengaged position, so that the bucket can be used to move or otherwise reposition the screened dirt/topsoil or for any other traditional function associated with said buckets.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a front perspective view of one possible embodiment of a dirt-screening bucket attachment of the present invention removably attached to a bucket in accordance with the disclosed architecture;

FIG. 2 illustrates a rear perspective view of one possible embodiment of the dirt-screening bucket attachment of the present invention removably attached to a bucket in accordance with the disclosed architecture;

FIG. 3 illustrates a side perspective view of one possible embodiment of the dirt-screening bucket attachment of the present invention removably attached to a bucket of a skid steer (shown as prior art) in accordance with the disclosed architecture; and

FIG. 4 illustrates a rear perspective view of another possible embodiment of the dirt-screening bucket attachment of the present invention removably attached to a bucket in accordance with the disclosed architecture, wherein the screen portion is outwardly bulbous.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof.

As noted above, there exists a long-felt need in the art for a dirt-screening bucket attachment device that can be easily and removably attached to the existing bucket of a skid steer or other piece of earth-moving machinery. Further, there exists a need for a dirt-screening bucket attachment device that may remain attached to and that does not unduly interfere with the operation of the bucket when the attachment is not needed. There is also a long-felt need in the art for a dirt-screening bucket attachment device that provides a lower cost alternative to existing dirt-screening attachments, which are typically are comprised of both a bucket portion and a dirt-screening portion.

The dirt-screening bucket attachment device of the present invention is designed to allow a user to utilize the existing bucket of a skid steer as intended and in an uninterrupted manner, while also retaining the functionality of the bucket attachment device. To do so, the bucket attachment device can be positioned in a stowed or disengaged position such that it does not obstruct the bucket of the skid steer. However, the attachment is also easily repositionable from an engaged position wherein the attachment covers the existing bucket of a skid steer. As such, it can then be used in conjunction with skid steer bucket to screen dirt, topsoil and other sortable materials. This can be achieved by shaking the bucket while raising/lowering the bucket of the skid steer via the hydraulic assembly with the screening device attached to the bucket and in the engaged position. Accordingly, as the bucket is being shaken and raised and lowered, finer particles such as dirt and topsoil are permitted to pass through the top and front screens with the assistance of gravity, while larger particles such as rocks, roots and other debris are prevented from passing through the screens and may be appropriately disposed of later.

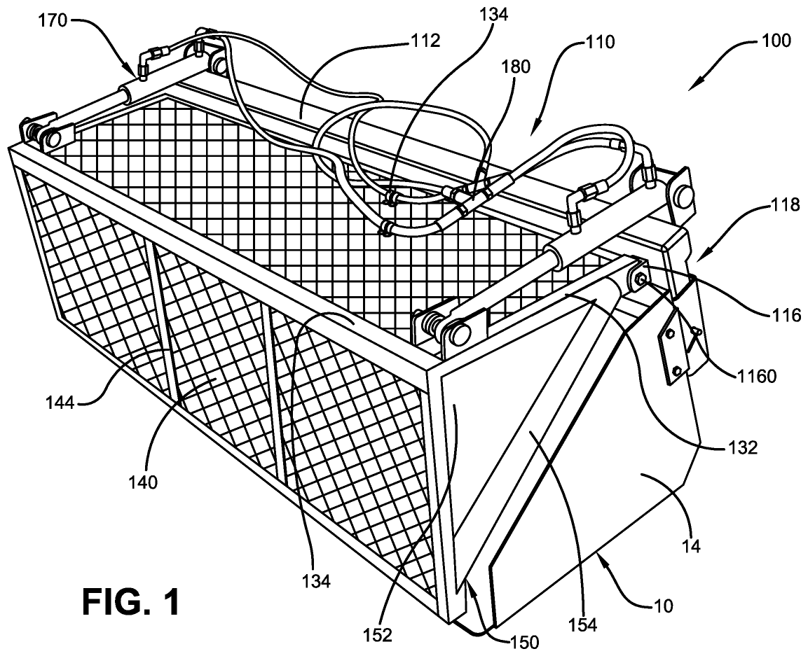

Referring initially to the drawings, FIG. 1 illustrates a front perspective view of one potential embodiment of an improved dirt-screening bucket attachment device 100 of the present invention attached to a bucket 10 (shown as prior art) of a skid loader 11. It is appreciated that in differing embodiments, the bucket attachment device 100 can be designed with specific architecture to be applied to any bucket 10 or bucket-like structure commonly used on a skid steer 11 or other earth or material-moving equipment such as a backhoe, excavator, etc. The bucket attachment device 100 is primarily comprised of a structural frame 110, a mounting assembly 118, a top screen 130, a front screen portion 140, two opposing side members 150, and a hydraulic assembly 170. Unless otherwise stated herein, the various components of the screening attachment device are preferably comprised of a steel or other durable metal such as aluminum or other metal of the like.

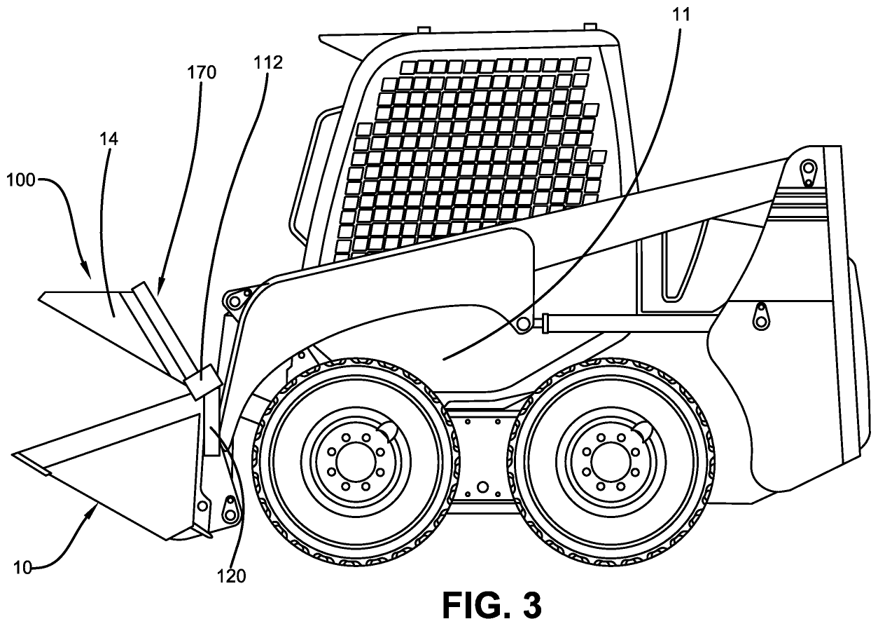

The frame 110 is preferably comprised of a generally rectangular central frame arm 112 that is further comprised of at least one (but preferably two) male rectangular mounting shafts 114 that are fixedly and perpendicularly attached to each end of the frame arm 112. As will be noted more fully below, each shaft 114 will be received within a mounting receiver 120 of the mounting assembly 118. The frame arm 112 is also comprised of at least two hinges 116 that are also located on each end of the frame arm 112 and are further comprised of a hinge pin 1160 which secures each hinge 116 to the lateral frame members 132. As seen in FIG. 3 and as discussed more fully below, the hinges 116 allow the device 100 to articulate upwards when not in use to preserve the full functionality of the existing bucket 10.

The mounting assembly 118 of the bucket attachment device 100 is comprised of at least one rectangular female mounting receiver 120, at least one mounting bracket 122, and at least one mounting pin 124, wherein the mounting receiver 120 receives a male mounting shaft 114 of the frame arm 112. Accordingly, the shaft 114 is then secured through both the receiver 120 and the shaft 114 via a mounting pin 124 via a continuous opening within both the receiver 120 and the shaft 114. It is further contemplated that said mounting pin 124 can be any of a plurality of differing pin types that can successfully secure the frame 110 to the mounting assembly 118 such as but not limited to: a cotter pin, a spring pin, a hitch spin, a lock pin, etc. It is also contemplated that the mounting bracket 122 is preferably secured to a rear surface 12 of a bucket 10 via a bolt-on assembly system, which may be comprised of, but is not limited to, various removable bolt and washer assemblies known in the art. However, in one embodiment of the device 100, the mounting bracket 122 may be fixedly attached (e.g. welded) to the rear surface 12.

The frame 110 is also comprised of a top screen 130 and the front screen 140, wherein each screen 130, 140 is further comprised of a plurality of frame members. More specifically, the top screen 130 is preferably generally rectangular in shape and comprised of two generally parallel and spaced-apart lateral frame members 132 that are connected to one another by two generally parallel and spaced-apart longitudinal frame members 134, thereby forming a generally rectangular frame to support and provide structural integrity to the mesh portion of top screen 130, as best shown in FIG. 1. Further, as stated above, the frame 110 is also comprised of at least one hinge 116 and a hinge pin 1160, which is fixedly connected (preferably via a weld) to a lateral frame member 132 on each side of the screening attachment device 100, and also to the central frame arm 112.

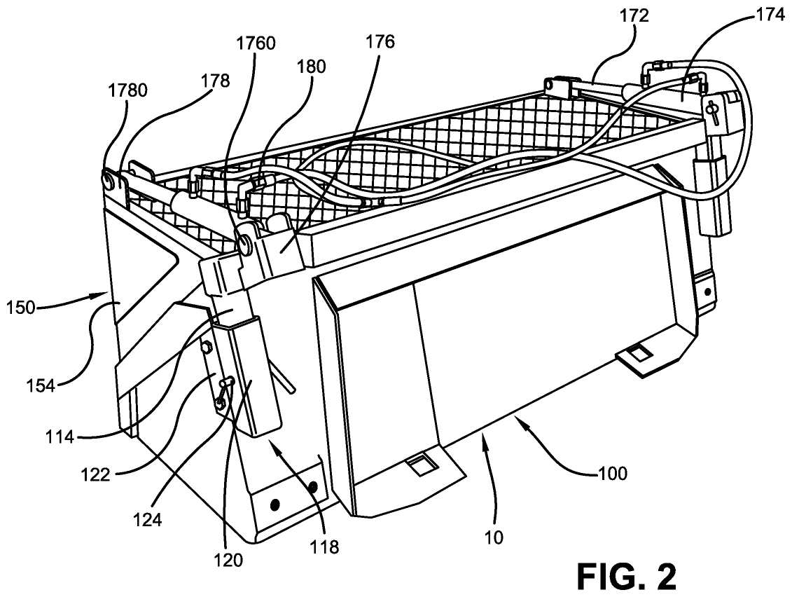

Accordingly, the hinge 116 allows the screening attachment device 100 to pivot or articulate between an engaged position, wherein the screening attachment device 100 is placed directly over and covers the front opening of the bucket 10 (e.g., to be used to screen the dirt or topsoil within the bucket) as shown in FIGS. 1 and 2, and a disengaged or stowed position as seen in FIG. 3, meaning that the bucket attachment device 100 is raised above or away from the bucket 10 via a hydraulic assembly 170, so as to not otherwise interfere with the traditional operation of the bucket 10 when the device 100 is not needed.

Similarly, the front screen 140 is also generally rectangular in shape and comprised of a pair of generally parallel and spaced-apart horizontal members 142 connected together by two or more generally parallel and spaced-apart vertical members 144 that also provide structural support to the screen 140. As best shown in FIG. 1, one of the longitudinal frame members 134 of the top screen 130 may also serve as one of the horizontal members 142 of the front screen 140.

It is contemplated that both the top and front screens 130, 140 may be comprised of screens or mesh having different-sized openings therein to accomplish the sorting of different-sized materials within the bucket 10. It is also contemplated that the top and front screens 130, 140 may be easily removable and replaceable to allow a user to quickly change the screening capabilities of the screening attachment device 100 to suit a particular user need and/or preference. To aid in the quick-changing of the screens 130, 140 each screen may be magnetic such that it attaches to the metal frame 110 and all frame members. Further, each frame 130, 140 may be comprised of a kit of various screens with various openings of differing sizes, shapes and/or thicknesses to easily screen out specific materials. In addition, it is contemplated that in differing embodiments of the device 100, each screen 130, 140 may vary in shape and may be generally square, triangular, spherical, oblong and may further be three-dimensional.

As stated above and best shown in FIGS. 2 and 3, the bucket attachment device 100 is also comprised of a pair of generally parallel and spaced-apart opposing sides 150 that are generally diagonal in shape to correspond to the opposed diagonal sides 14 of a bucket 10. The sides 150 are further comprised of a generally triangular cover plate 152 and a diagonal frame member 154 to structurally reinforce the sides 150. In an alternative embodiment of the present invention, the cover plates 152 may also be comprised of mesh screens (not shown) to further facilitate the additional screening of the contents of the bucket 10, provided the bucket 10 is shaken in a side-to-side motion. Like differing embodiments of the top 130 and front 140 screens, the cover plate 152 screens may be magnetic such that they attach to the metal frame 110 and all frame members. Further, the cover plate 152 screens may come as a kit of various screens with various openings of various sizes, shapes and thicknesses to easily screen out specific materials.

The hydraulic assembly 170 of the screening attachment device 100 can best be observed in FIG. 2 and is comprised of at least one hydraulic arm/piston 172 and a housing 174 for said arm/piston 172. However, the bucket attachment device 100 is preferably comprised of two hydraulic assemblies 170, one positioned on each end of the device 100 as shown in the FIGS. Accordingly, each hydraulic assembly 170 is connected to one another via a series of hydraulic hoses 180, which allow hydraulic fluid to reach the pistons 172, which in turn allow for the articulation of the bucket attachment 100 between the engaged and disengaged positions as described above and shown in FIG. 3. It is further contemplated that the assembly 170 may be in power communication with the existing hydraulic system of the skid steer 11 or other earth-moving machinery.

The articulation of the device 100 is also made possible via a first hinge 176 and a second hinge 178 that comprises each hydraulic assembly 170, and are each positioned on a side of the screening attachment device 100, as best shown in FIG. 2. The first hinge 176 is fixedly attached (preferably via a weld) to the frame members 132, 134 of the top screen 130, and the second hinge 178 is fixedly attached (preferably via a weld) to the central frame arm 112. The piston 172 is also connected to the second hinge 178 via a hinge pin 1780, and the piston housing 174 is similarly connected to the first hinge 176 via a hinge pin 1760. Said hinges 176, 178 and pins 1760, 1780 thus allow the screening attachment device 100 to be articulated via the extension/retraction of the piston 172 to an angle of at least 90 degrees relative to the bucket 10 when it is in the disengaged or stowed position, so as to not interfere with the normal operation of the bucket 10.

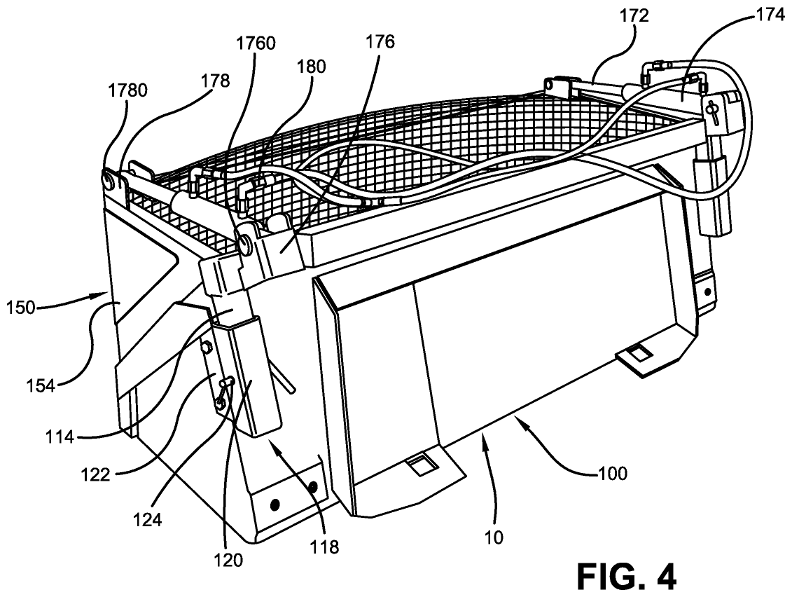

FIG. 4 illustrates a rear perspective view of another possible embodiment of the dirt-screening bucket attachment device 100 of the present invention removably attached to a bucket in accordance with the disclosed architecture, wherein the screen portion is outwardly bulbous. More specifically, the screen portion extends outwardly from the bucket in a bulbous or bubble-like configuration. It is contemplated that either or both of the top screen portion 130 and/or the front screen portion 140 maybe bulbous or bubble like in configuration.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “dirt-screening bucket attachment device”, “bucket attachment device”, “attachment”, and “device”, are interchangeable and refer to the dirt-screening bucket attachment device 100 of the present invention.

Notwithstanding the forgoing, the dirt-screening bucket attachment device 100, and its various components, can be of any suitable size, shape, and configuration as is known in the art without affecting the overall concept of the invention, provided that it accomplishes the above-stated objectives. One of ordinary skill in the art will appreciate that the shape and size of the dirt-screening bucket attachment device 100 and its various components, as shown in the FIGS. are for illustrative purposes only, and that many other shapes and sizes of the dirt screening bucket attachment device 100 are well within the scope of the present disclosure. Although dimensions of the dirt-screening bucket attachment device 100 and its components (i.e., length, width, and height) are important design parameters for good performance, the dirt-screening bucket attachment device 100 and its various components may be of any shape or size that ensures optimal performance during use and/or that suits user need and/or preference.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A dirt screening attachment device for use with a bucket, the dirt screening attachment device comprising:
a frame;
a top screen portion;
a front screen portion;
a pair of opposing side members;
a mounting assembly; and
a hydraulic assembly.

2. The dirt screening attachment device of claim 1, wherein the dirt screening attachment device is repositionable between an engaged position and a disengaged position.

3. The dirt screening attachment device of claim 2, wherein the dirt screening attachment device substantially covers an opening in the bucket when the dirt screening attachment device is in the engaged position.

4. The dirt screening attachment of claim 2, wherein the dirt screening attachment device does not unduly interfere with a normal operation of the bucket when the dirt screening attachment device is in the disengaged position.

5. A dirt screening attachment device for use with a bucket, the dirt screening attachment device comprising:
a frame comprised of a plurality of frame members;
a top screen portion and a front screen portion, wherein each of the top screen portion and the front screen portion that share a common frame member of the plurality of frame members;
two opposing side members;
at least one mounting assembly; and
at least one hydraulic assembly.

6. The dirt screening attachment device of claim 5, wherein the frame is comprised of a steel.

7. The dirt screening attachment device of claim 5, wherein the frame is comprised of an aluminum.

8. The dirt screening bucket attachment device of claim 5, wherein the frame is comprised of a durable metal, and further wherein at least one of the top screen portion and the front screen portion is bulbous.

9. A dirt screening bucket attachment device for use with a bucket, the dirt screening bucket attachment device comprising:
a generally rectangular frame;
a rectangular top mesh screen portion;
a rectangular front mesh screen portion, wherein each of the rectangular top mesh screen portion and the rectangular front mesh screen portion share a common frame member;
a pair of opposing side members;
at least two side covers;
a mounting assembly; and
a hydraulic assembly for articulating the dirt screening bucket attachment device from a position in front of the bucket to a position above the bucket.

10. The dirt screening bucket attachment device of claim 9, wherein the rectangular top mesh screen magnetically attaches to the generally rectangular frame.

11. The dirt screening bucket attachment device of claim 9, wherein the rectangular front mesh screen portion magnetically attaches to the generally rectangular frame.

12. The dirt screening bucket attachment device of claim 9 further comprising a plurality of interchangeable screens.

13. The dirt screening bucket attachment device of claim 12, wherein each of the plurality of interchangeable screens are comprised of a plurality of openings having differing sizes, shapes or thicknesses.

14. The dirt screening bucket attachment device of claim 9, wherein the hydraulic assembly is comprised of at least one piston.

15. The dirt screening bucket attachment device of claim 14, wherein the hydraulic assembly is comprised of at least one piston housing.

16. The dirt screening bucket attachment device of claim 15, wherein the hydraulic assembly is comprised of at least one hinge.

17. The dirt screening bucket attachment device of claim 16, wherein each of the at least two side covers is comprised of a mesh screen.

18. The dirt screening bucket attachment device of claim 17, wherein each of the at least two side cover magnetically attach to the generally rectangular frame.

19. The dirt screening bucket attachment device of claim 18, wherein each of the at least two side covers is comprised of a plurality of interchangeable side screens, and further wherein each of the plurality of interchangeable side screens are comprised of a plurality of openings having differing sizes, shapes or thicknesses.

20. The dirt screening bucket attachment device of claim 19, wherein the mounting assembly is fixedly attached to the rear surface of the bucket, and further wherein both the rectangular top mesh screen portion and the rectangular front mesh screen portion are bulbous in a direction opposite of the bucket.
